(19) United States
(12) Patent Application Publication
(10) Pub. No.: US 2003/0182185 A1
(43) Pub. Date: Sep. 25, 2003

(54) Split incentive customer referral scheme

(76) Inventor: Vivek Dodd, London (GB)

Correspondence Address: Vivek Dodd, 50 Alderton Hill, Loughton, IG10 3JB, GB

(21) Appl. No.: 10/086,280

(22) Filed: Mar. 4, 2002

(51) Int. Cl. G06F 17/60

(52) U.S. Cl. 705/14

(57) ABSTRACT

The present invention provides a method and an internet-based system aimed specifically at soliciting the help of existing customers of an internet-based service to market the service to new customers. The system embodies customer account management and a split incentive scheme that compensates the existing customer who acts as a referrer and the new customer who has been referred.

### CROSS REFERENCE TO RELATED APPLICATIONS

Not applicable.

### STATEMENT REGARDING FEDERALLY SPONSORED RESEARCH OR DEVELOPMENT

Not applicable.

### COMPUTER PROGRAM LISTING

Not applicable.

### BACKGROUND

1. Field of the Invention

The present invention provides a method and an internet-based system aimed specifically at soliciting the help of existing customers of an internet-based service to market the service to new customers.

2. Description of Prior Art

Existing customers of a company are potentially its greatest marketing agents if they are satisfied with its products and services. Customer referrals are more powerful and less expensive than any other form of marketing.

For internet-based services the potential for customer referrals is even more enormous given the low cost and ease of transactions on the Internet.

The concept of simply using customer and non-customer referrals is not new. Firms often employ agents, associates and other to promote their products in return for some compensation.

However, a problem arises when the existing customers are peers or colleagues of the potential customers who are being referred. In this case the existing customers are hesitant to refer their peers to the service if they are seen to be making a personal gain from this action. On the other hand the absence of any compensation reduces the incentive for existing customers to give referrals.

This problem has been solved in this invention by giving an incentive to existing customers to give referrals and simultaneously making it more attractive for potential customers to make their purchase via the customer referral.

### BRIEF SUMMARY OF THE INVENTION

It is an object of the present invention to provide a method and an internet-based system aimed specifically at soliciting the help of existing customers of an internet-based service to market the service to new customers. The system embodies customer account management and a split incentive scheme that compensates both the existing customer who acts as a referrer and the new customer who has been referred.

### DRAWINGS

Not applicable.

### DETAILED DESCRIPTION OF THE INVENTION

The present invention provides a methodology and a computer-based system aimed specifically at soliciting the help of existing customers of an internet-based service to market the service to new customers.

The system embodies customer account management and a split incentive scheme that compensates the existing customer who acts as a referrer and the new customer who has been referred.

Every existing customer of the internet-based service is given an account and a unique code to access that account. The existing customer is informed of this unique code by email and encouraged to market the internet-based service to his or her peers/colleagues. When a new customer buys the internet-based service using a unique code of an exiting customer, that customer's account is credited by a specified amount. Customer accounts are settled on a specified date or at specified intervals.

Simultaneously, the new customers are incentivized by giving them a discount to the purchase price upon using this code and said discount is bigger any other promotional discounts that the internet-based service may offer. This allows existing customers to recommend the internet-based service to his or her peers in full confidence that they are obtaining the best deal available for their peers/colleagues.

### LIST OF PRIOR ART

A review of the prior art has turned up no customer referral scheme that uses the power of existing customers of an internet-based service by giving an incentive that is split between the existing customer who acts as a referred and a new customer who has been referred.

Some of the patents in the area of customer referral schemes are listed below.

U.S. Pat. No. 6,164,974 (issued Dec. 26, 2000) provides an evaluation based learning system to develop, teach and administer courses.

U.S. Pat. No. 3,899,775 Larsen

U.S. Pat. No. 4,799,156 Shavit et al.

U.S. Pat. No. 4,984,155 Geire et al.

U.S. Pat. No. 4,992,940 Dworkin

U.S. Pat. No. 5,319,542 King, Jr. et al.

U.S. Pat. No. 5,537,314 Kanter.

U.S. Pat. No. 5,590,197 Chen et al.

U.S. Pat. No. 5,712,979 Graber et al.

U.S. Pat. No. 5,715,314 Payne et al.

U.S. Pat. No. 5,717,860 Graber et al.

U.S. Pat. No. 5,724,424 Gifford et al.

U.S. Pat. No. 5,745,681 Levine et al.

U.S. Pat. No. 5,812,769 Graber et al.

U.S. Pat. No. 5,819,285 Damico et al.

U.S. Pat. No. 6,029,141 Bezos, et al.

What is claimed is:

1. A method of selling subscriptions to an internet-based service with the help of existing customers comprising:
a) providing an internet-based system that maintains accounts for said existing customers of said internet-based service;
b) providing said existing customers with a unique code by email, which said existing customers can give to other potential customers of said internet-based service;
c) receiving said code from a new customer at the time of sale, and if said code is recognized, automatically giving a discount to said new customer that is larger than any other promotional discount offered for said internet-based service;
d) adding a specified incentive compensation to the account of the said existing customer in lieu of said sale.
